(19) United States
(12) Patent Application Publication
(10) Pub. No.: US 2003/0155368 A1
(43) Pub. Date: Aug. 21, 2003

(54) Magnetic strip with adhesive layer

(76) Inventor: Zanetti Giancarlo, Milano (IT)

Correspondence Address: Robert M Haroun, Sofer & Haroun, Suite 1921, 342 Madison Avenue, New York, NY, 10173, US

(21) Appl. No.: 10/257,799

(22) PCT Filed: Apr. 24, 2001
(86) PCT No.: PCT/IT01/00201

(30) Foreign Application Priority Data
Apr. 28, 2000 (IT) MI2000A000944

(51) Int. Cl. G07F 11/72

(52) U.S. Cl. 221/30

(57) ABSTRACT

A magnetic strip (100) comprises a substrate element (105) having a first principal surface and a second principal surface disposed opposite one another, a layer of magnetic material (110) disposed on the first surface of the substrate element (105), and a layer of adhesive material (115) disposed on the second surface of the substrate element (105).

The present invention relates to a magnetic strip.

Magnetic strips are commonly used in various applications such as, for example, in credit cards, identity badges, parking tickets, telephone cards, and the like.

Typically, the magnetic strip is incorporated in a card made of plastics material, during its manufacture (for example, for credit cards and identity badges). Alternatively, the magnetic strip is printed on a paper card (for example, for parking tickets and telephone cards).

A disadvantage of the known solutions described above is that the production of the magnetic strip in any case requires a stage of industrial processing of the plastics or paper card. This makes it extremely difficult to use magnetic strips on objects of other types or on already-existing objects such as, for example, a book.

Moreover, the card (plastics or paper) is subject to considerable mechanical and thermal stresses during the production of the magnetic strip. These stresses may damage the card and in any case make it impossible to form a magnetic strip on particularly delicate substrates such as, for example, photographic paper.

The object of the present invention is to prevent the above-mentioned problem. To achieve this object, a magnetic strip as described in the first claim is proposed.

Briefly, a magnetic strip is provided comprising a substrate element having a first principal surface and a second principal surface disposed opposite one another, a layer of magnetic material disposed on the first surface of the substrate element, and a layer of adhesive material disposed on the second surface of the substrate element.

Moreover, the present invention also proposes a magnetic device comprising the magnetic strip, a dispenser for the magnetic strip, and a corresponding method of producing the magnetic strip.

Further characteristics and the advantages of the magnetic strip according to the present invention will become clear from the following description of a preferred embodiment thereof, given by way of non-limiting example with reference to the appended drawings, in which:

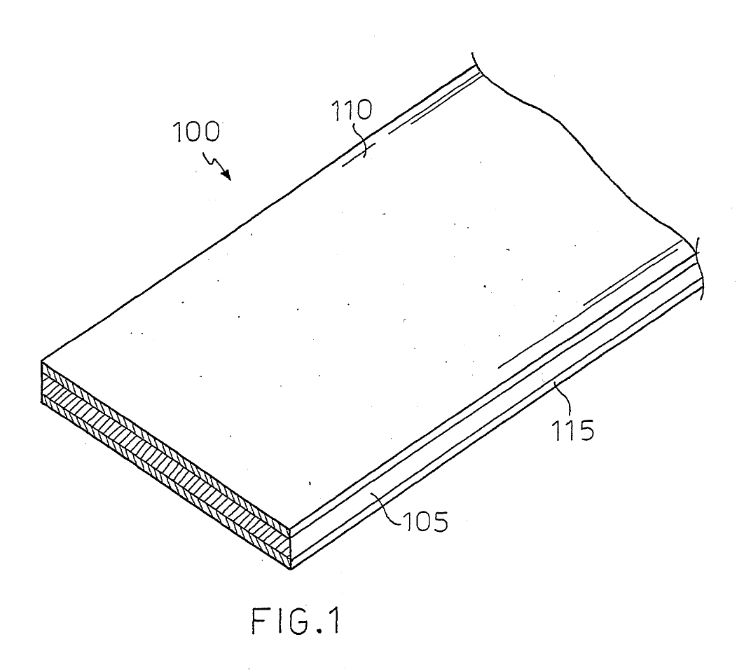

FIG. 1 shows the magnetic strip in section,

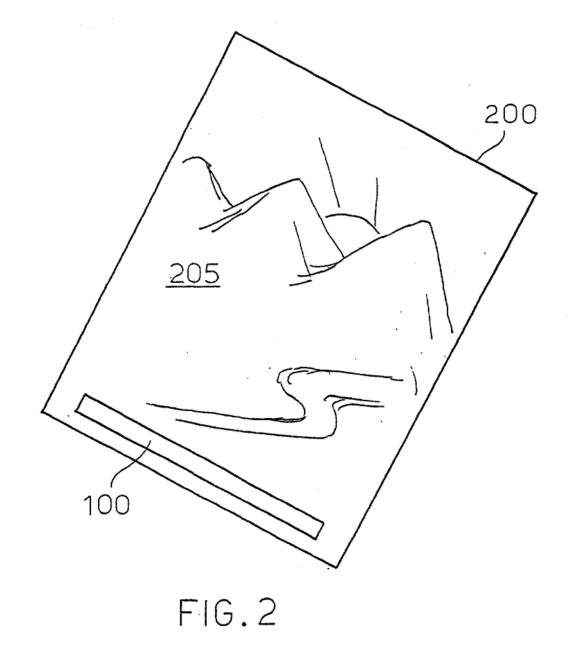

FIG. 2 is a magnetic device in which the magnetic strip of the present invention can be used,

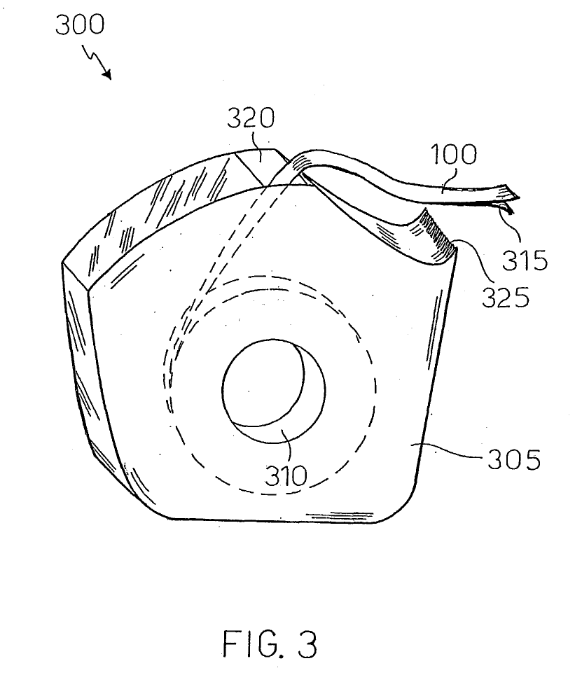

FIG. 3 shows a dispenser for the magnetic strip,

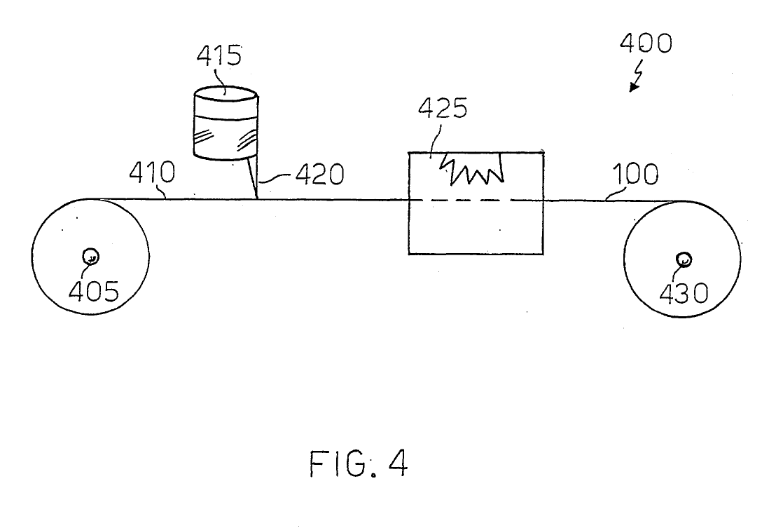

FIG. 4 shows a system usable for producing the magnetic strip.

With reference in particular to FIG. 1, this shows a magnetic strip 100. The magnetic strip 100 includes a substrate element 105 constituted by a long, straight portion of thin material (for example, with a thickness of 12.5 μm). A layer of ferromagnetic material 110 is arranged on a principal surface of the substrate element 105 (for example, an upper surface); the layer of ferromagnetic material 110 preferably has a thickness of 3.5 μm and a coercivity of 30 kA/m (375 Oe).

Similar considerations apply if the substrate element or the layer of ferromagnetic material have a different thickness or if the layer of ferromagnetic material has different characteristics.

In the magnetic strip 100 of the present invention, a layer of adhesive material 115 is provided on the other principal surface of the substrate element 105 (a lower surface in the embodiment illustrated).

The magnetic strip thus produced can be applied to any object extremely easily. This is achieved without the need for any industrial processing of the object to which the magnetic strip is to be applied; this avoids the subjection of the object to mechanical and thermal stresses typical of such a processing step. The solution of the present invention thus enables the magnetic strip to be applied even to particularly delicate substrates.

With reference, for example, to FIG. 2, this shows a piece of photographic paper 200 on which a photograph 205 is printed. A portion of the magnetic strip 100 is glued (by means of the adhesive layer) to the photographic paper 200, for example, in the vicinity of a lower edge thereof. The magnetic strip 100 is used to record information relating to the photograph 205 (such as the date, subject, etc.). This information is written on the magnetic strip 100 with the use, for example, of a recording/playback pen as described in the document WO-A-97/10590.

Similar considerations apply if the magnetic strip is glued to a page of a book (in order to record the pronunciation of a text in a foreign language), on a board for children (for recording the name of an object depicted), on a package (for recording the contents and other information, such as an expiry date for use by the sightless) or, more generally, on a main body of any magnetic device.

With reference now to FIG. 3, the substrate element of the magnetic strip 100 is preferably constituted by a flexible tape. This enables the magnetic strip 100 to be applied to objects of any shape, for example, to curved surfaces.

The magnetic strip 100 is advantageously housed in a dispenser 300. The dispenser 300 is constituted by an enveloping plastics casing 305. Inside the casing 305 there is a cylindrical core 310 around which the magnetic strip 100 is wound. A flexible protective tape (for example, made of 80 g glassine with a thickness of 10-15 μm) is disposed on the adhesive layer of the magnetic strip 100 to prevent damage to the magnetic strip. A free end of the magnetic strip 100 emerges from the casing 305 through a slot 320. Externally, the casing 305 has a serrated edge 325 for cutting the magnetic strip 100. This dispenser 300 makes the use of the magnetic strip 100 extremely practical.

Similar considerations apply if the dispenser has a different structure, for example, if the serrated edge is replaced by other equivalent means for manual cutting of the magnetic strip, if the protective tape is made of a different material and with a different thickness, if there is no casing or no serrated edge, or if the magnetic strip is wound around the core without the protective tape (with the use, for example, of an adhesive layer with low adhesive strength). Alternatively, the magnetic strip is pre-cut into adhesive labels, the substrate element is stiff, etc.

An example of a system usable for the production of the above-described magnetic strip is shown in FIG. 4. This system, indicated 400 in the drawing, includes a supply roller 405 around which a roll of adhesive tape 410 is wound. The adhesive tape 410 is unwound from the supply roller 405 and is made to pass in the vicinity of a reservoir 415; a magnetic paste constituted by a mixture of ferromagnetic oxide, vitreous substrate material, and organic binding material (solvents and binders) is loaded into the reservoir 415. The reservoir 415 has a nozzle 420 which is used to spread the magnetic paste on an upper (non-adhesive) surface of the tape 410. The adhesive tape 410 (covered with the magnetic paste) is transferred to a drying oven 425 so as to evaporate the solvent and to cause the magnetic paste to adhere to the adhesive tape. The magnetic strip 100 thus produced is collected by a winding roll 430.

Preferably, the substrate element of the magnetic strip 100 is made of polyester and the adhesive layer is made of acrylic material in aqueous emulsion (with a density of 20 g/m³). These materials allow the adhesive tape 410 to be subjected to the drying step in the oven 425 without undergoing any damage.

The above-described method for the production of the magnetic strip is extremely quick and economical. Moreover, the fact that the adhesive layer is spread on the substrate element before the magnetic layer prevents the magnetic layer from being spoilt by the adhesive material.

Similar considerations apply if the magnetic paste has a different composition, if a different system is used for supplying the adhesive tape, etc. Alternatively, the substrate element is made of another material (for example, a paper material), if a different adhesive material is used, if the magnetic layer is spread on the substrate element before the adhesive layer, if the magnetic strip is produced by a spraying process, a rotogravure process, by electrostatic systems, etc.

Naturally, in order to satisfy contingent and specific requirements, a person skilled in the art may apply to the above-described magnetic strip many modifications and variations all of which, however, are included within the scope of protection of the invention as defined by the appended claims.

1. A dispenser (300) of a magnetic strip (100), said dispenser including a core (310) and said magnetic strip (100), the magnetic strip being wound around the core and comprising:
a substrate element (105) having a first principal surface and a second principal surface disposed opposite one another,
a layer of magnetic material (110) for recording information disposed on the first surface of the substrate element (105),
a layer of adhesive material (115) disposed on the second surface of the substrate element (105), said adhesive material allowing to glue at least a portion of the magnetic strip (100) to an object,
said dispenser being characterised by comprising a flexible protective tape (315) disposed on the layer of adhesive material (115) for preventing damage of the magnetic material (110) of said magnetic strip (100) wound around the core (310), or, if the magnetic strip is wound around the core without the protective tape, the magnetic strip being characterised in that the layer of adhesive material has a low adhesive strength.

2. A dispenser (300) according to claim 1 in which the substrate element (105) is constituted by a flexible tape.

3. A dispenser (300) according to claim 2, in which the substrate element (105) is made of polyester.

4. A dispenser (300) according to any one of claims 1 to 3 in which the layer of adhesive material is made of acrylic material in aqueous emulsion.

5. A dispenser (300) according to claim 1, further comprising a casing (305) enveloping the magnetic strip (100), the casing (305) having a slot (320) through which the magnetic strip (100) can emerge.

6. A dispenser (300) according to any one of claims 1 to 5, further comprising means (325) for manual cutting of the magnetic strip (100).

7. A dispenser (300) according to claim 6, wherein the means (325) for manual cutting of the magnetic strip (100) comprise a serrated edge (325) of the casing (305).

8. A dispenser (300) according to claim 1, wherein said magnetic material (110) comprises a magnetic oxide paste.
